(19) United States
(12) Patent Application Publication
(10) Pub. No.: US 2002/0166224 A1
(43) Pub. Date: Nov. 14, 2002

(54) Method for making cooking utensils with patterns

(76) Inventor: Cheng-Chieh Lee, Kaohsiung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/851,167

(22) Filed: May 9, 2001

(51) Int. Cl. B23P 25/00

(52) U.S. Cl. 29/527.4

(57) ABSTRACT

A method for making cooking utensils with patterns includes actions of forming patterns on a thin metal plate by a roller, shaping the metal plate into a cooking utensil, and applying Teflon on the cooking utensil. The roller is engraved with patterns previously such that same patterns can form on the metal plate when the roller is rolling on the metal plate. The metal plate is shaped into a cooking utensil by a pressing machine. A handle can be fitted to the cooking utensil. And, the Teflon is applied on the cooking utensil for preventing foods from sticking to the same.

### BACKGROUND OF THE INVENTION

The present invention relates to a method for making cooking utensils with patterns, and particularly to one which is safe, efficient, and doesn't pollute the environment.

There are three common methods for making cooking utensils with patterns: etching, pressing, and grinding by an emery wheel.

To make patterns on a cooking utensil by etching, corrosive liquid is used to destroy the metal part of the cooking utensil for patterns to be formed. The corrosive liquid would pollute the cooking utensil. And, it is a problem to dispose of the corrosive liquid after use such that same won't pollute the environment.

To make patterns by pressing, first, metal is made into cooking utensil. And, then a mould having patterns is pressed onto the cooking utensil. Patterns can only be formed on a part of the cooking utensil in the method. And, it needs a relatively force and lots of electricity, and causes loud noises to form patterns by this method.

The method of making patterns by an emery wheel, such as is disclosed in Taiwan Patent, No. 293791, needs to dispose an utensil on a swivel plate, and put the emery wheel onto the cooking utensil to engrave same with patterns; an advantage of the method is that the width of the patterns (lines) can be controlled by the depth of the emery wheel cutting into the cooking utensil. However, the method needs much labor, and can't produce efficiently. And, the sparks caused in the grinding process is dangerous, and likely to cause a fire.

### SUMMARY OF THE INVENTION

Therefore, it is a main object of the present invention to provide a method for making cooking utensils with patterns which is safe, efficient, and doesn't pollute the environment.

The method for making cooking utensils with patterns includes the following actions:

1. rolling a roller engraved with patterns on a thin metal plate for same patterns the form on the thin metal plate;

2. shaping the metal plate into a cooking utensil by means of a pressing machine;

3. applying Teflon on the cooking utensil for preventing foods from sticking to the same;

4. fitting a handle to the cooking utensil.

Because the method uses a roller to form patterns on the metal plate, it takes less labor, and is easier, and quicker than the conventional methods. And, it doesn't cause sparks or use corrosive chemical substances.

### BRIEF DESCRIPTION OF THE DRAWINGS

This invention will be better understood by referring to the accompanying drawings, wherein:

FIG. 1 is a flow chart of the method for making cooking utensils with patterns according to the present invention.

FIG. 2 is a view showing the actions of the method for making cooking utensils with patterns according to the present invention.

FIG. 3 is a view of a cooking utensil being made to have patterns by means of the method of Taiwan Patent, No. 293791.

FIG. 4 is a view of a finished cooking utensil with patterns by the method of Taiwan Patent, No. 293791.

FIG. 5 is a photo of a finished cooking utensil with patterns by the method of the present invention.

### DETAILED DESCRIPTION OF THE PREFERRED EMBODIMENT

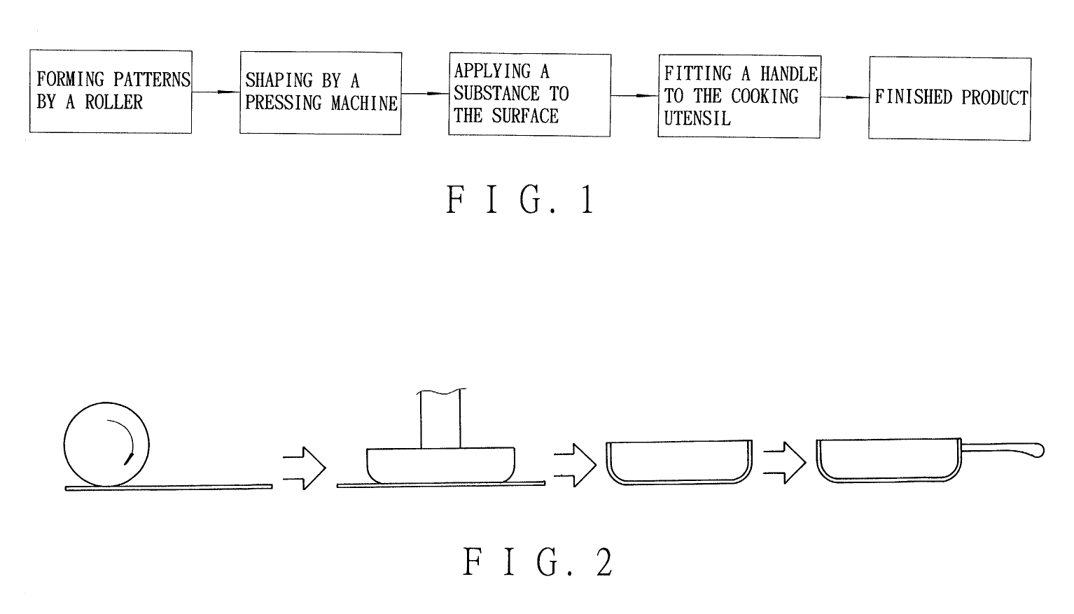

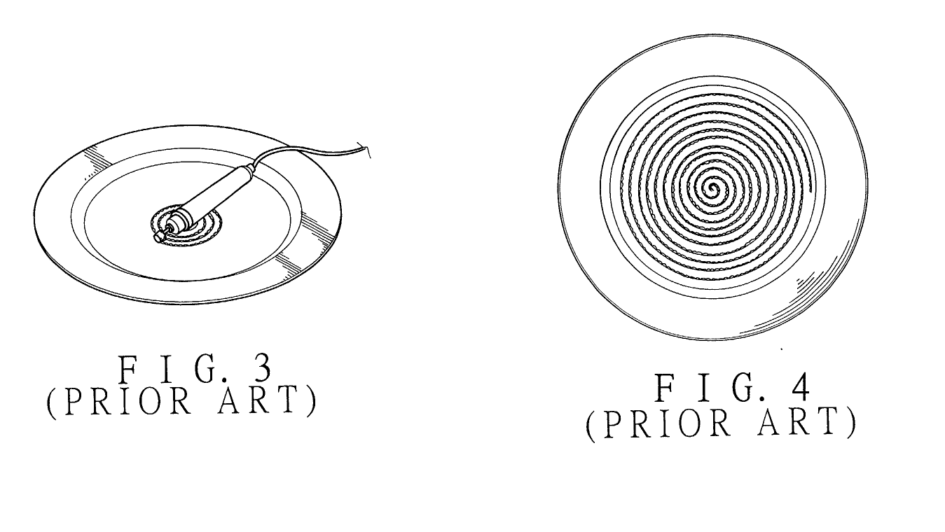

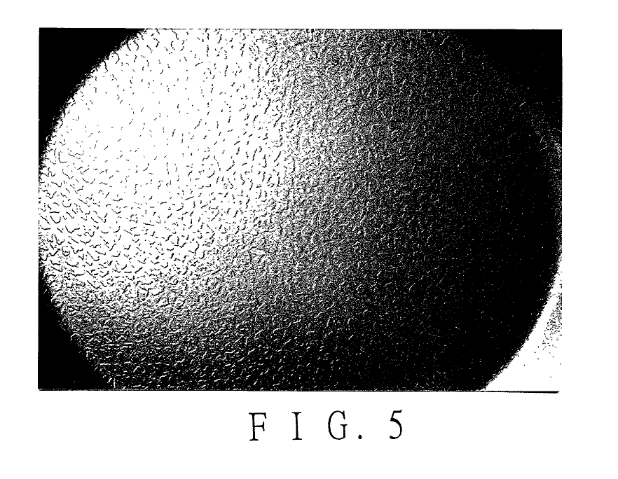

Referring to FIGS. 1 and 2, a method for making cooking utensils with patterns according to the present invention includes actions as follows:

1. rolling a roller on a thin metal plate; the roller is engraved with a pattern previously for the thin metal plate to have a same pattern formed on it;

2. pressing the metal plate by a pressing machine for same to become a cooking utensil of the desired kind, such as pan and pot;

3. applying Teflon on the cooking utensil to prevent foods from sticking to the same in cooking;

4. fitting a handle to the cooking utensil if necessary.

Because the method of the present invention makes patterns on the cooling utensil by rolling a roller on the material of the same, it takes relatively little labor, and is fast, and easy when compared with the conventional methods. And, the method is neither dangerous nor harmful to the environment because it doesn't cause sparks in processing, or use corrosive chemical liquids like the conventional methods.

From the above description, it can be easily understood that the method of the present invention has advantages over the conventional methods in the Background.

What is claimed is:

1. A method for making cooking utensils with patterns, comprising actions of:
(a) rolling a roller engraved with patterns on a metal plate for said metal plate to have same patterns formed thereon;
(b) shaping said metal plate into a cooking utensil;
(c) applying a substance capable of keeping off sticking foods on said cooking utensil.

2. The method for making cooking utensils with patterns of claim 1 further comprising an action of fitting a handle to said cooking utensil.

3. The method for making cooking utensils with patterns, wherein said substance capable of keeping off sticking food is Teflon.
